(19) United States
(12) Patent Application Publication
(10) Pub. No.: US 2015/0022759 A1
(43) Pub. Date: Jan. 22, 2015

(54) Display with Radioluminescent Backlight Unit

(71) Applicant: Apple Inc., Cupertino, CA (US)

(72) Inventors: Jason J. Huey, San Francisco, CA (US); Kevin M. Keeler, Los Gatos, CA (US)

(21) Appl. No.: 13/945,388

(22) Filed: Jul. 18, 2013

(51) Int. Cl. G02F 1/1335

(52) U.S. Cl. CPC G02F 1/133617
USPC 349/65; 349/61; 362/97.1

(57) ABSTRACT

An electronic device is provided with a display such as a liquid crystal display mounted in an electronic device housing. The display may be provided with a backlight unit. The backlight unit may include radioluminescent backlight structures. The radioluminescent backlight structures include an ionizing radiation source that produces beta particles or other ionizing radiation. The radioluminescent backlight structures also include a phosphor that produces light in response to being struck by the ionizing radiation. The light produced by the phosphor passes through liquid crystal display layers and serves as backlight for the display. Photoluminescent material and light-emitting diodes may also be used to produce backlight for the display. The display backlight may have a light guide plate that is provided with light from the radioluminescent light source or other light source structures.

### BACKGROUND

This relates generally to displays for electronic devices and, more particularly, to displays with backlights.

Electronic devices often include displays. For example, cellular telephones and portable music players often include displays for presenting information to a user.

Displays such as liquid crystal displays are typically backlit using a backlight unit. The backlight unit contains a light guide plate that distributes light from a light-emitting diode across the back of the display. During operation, backlight from the backlight unit is transmitted through the liquid crystal display. When the backlight unit is active, a user can view images on the display, even in dim ambient lighting conditions.

In some devices such as portable electronic devices, high power efficiency is desirable to extend battery life. If care is not taken, display backlight units may consume excessive battery power and battery life may be shortened.

It would therefore be desirable to provide improved backlit displays for electronic devices.

### SUMMARY

An electronic device is provided with a display such as a liquid crystal display mounted in an electronic device housing. The display may have liquid crystal display layers that display images for a user. The display may be provided with backlight structures that provide backlight that passes through the liquid crystal display layers.

The backlight unit may include radioluminescent backlight structures. The radioluminescent backlight structures include an ionizing radiation source that produces beta particles or other ionizing radiation. The radioluminescent backlight structures also include a phosphor that produces light in response to being struck by the ionizing radiation. An encapsulating structure such as a glass enclosure may be used to enclose the ionizing radiation source and the phosphor.

The light produced by the phosphor passes through liquid crystal display layers and serves as backlight for the display. Photoluminescent material and light-emitting diodes may also be used to produce backlight for the display. For example, the display backlight may have a light guide plate that is provided with light from the radioluminescent light source along one of its edges and that is provided with light from an array of light-emitting diodes along another of its edges.

Lens structures may be used to concentrate light from the radioluminescent light source into edges of the light guide plate. The lens structures may be integrated into the enclosure of the backlight structures and may include separate lenses.

The display may have a first area that is provided with backlight from the radioluminescent backlight structures such as a border region or other portion of the display that overlaps the radioluminescent backlight structures. The display may also have a second area that is illuminated without backlight from any radioluminescent backlight structures. The second area may be illuminated by a light-emitting diode backlight unit or may be provided with an array of organic light-emitting diode pixels. Photoluminescent backlight structures may also be incorporated into a display having multiple types of backlight.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device such as a laptop computer with display backlight structures in accordance with an embodiment.

FIG. 2 is a perspective view of an illustrative electronic device such as a handheld electronic device with display backlight structures in accordance with an embodiment.

FIG. 3 is a perspective view of an illustrative electronic device such as a tablet computer with display backlight structures in accordance with an embodiment.

FIG. 4 is a perspective view of an illustrative electronic device such as a computer display with display backlight structures in accordance with an embodiment.

FIG. 5 is a perspective view of an illustrative electronic device such as a wristwatch device or other portable device with display backlight structures in accordance with an embodiment.

FIG. 6 a cross-sectional side view of an illustrative display of the type that may be used in devices of the types shown in FIGS. 1, 2, 3, 4, and 5 in accordance with an embodiment.

FIG. 7 is a perspective view of an illustrative display backlight unit with a rectangular footprint in accordance with an embodiment.

FIG. 8 is cross-sectional side view of the illustrative display backlight structures of FIG. 7 in accordance with an embodiment.

FIG. 9 is a cross-sectional side view of illustrative display backlight structures formed from an open-topped box covered with a mating planar lid in accordance with an embodiment.

FIG. 10 is cross-sectional side view of illustrative display backlight structures formed from a pair of mating planar layers joined with ring-shaped peripheral sealing structures in accordance with an embodiment.

FIG. 11 is a cross-sectional side view of a backlight unit with curved upper and lower surfaces in accordance with an embodiment.

FIG. 12 is a cross-sectional side view of illustrative backlight structure in which backlight is produced both from a radioluminescent light source and a light-emitting diode light source in accordance with an embodiment.

FIG. 13 is a cross-sectional side view of an illustrative radioluminescent light source with a concave lens formed as an integral portion of a glass light source enclosure that is being used to provide light to an edge of a light guide plate in a backlight unit in accordance with an embodiment.

FIG. 14 is a cross-sectional side view of an illustrative radioluminescent light source with a concave mirror structure that is being used to provide light to an edge of a light guide plate in a backlight unit in accordance with an embodiment.

FIG. 15 is a cross-sectional side view of an illustrative display having a partially reflective layer interposed between a radioluminescent backlight unit and a liquid crystal display in accordance with an embodiment.

FIG. 16 is a diagram showing how a display may have portions with a radioluminescent backlight and portions that are not backlight with a radioluminescent backlight in accordance with an embodiment.

### DETAILED DESCRIPTION

Displays in electronic devices such as liquid crystal displays may be provided with structures that emit backlight. These structures, which may sometimes be referred to as backlight units, backlights, or backlight structures, may provide illumination for a display that helps a user view images on the display. Backlight may be used, for example, to enhance the visibility of images that are displayed in bright ambient lighting conditions and to allow a user to view images in dim lighting conditions.

Displays may be provided with radioluminescent backlight structures. Radioluminescent backlight structures may include a source of ionizing radiation and a phosphor. The ionizing radiation source may emit ionizing radiation that strikes the phosphor and thereby causes the phosphor to emit light. The light emitted by the phosphor may be used as backlight for a display.

The ionizing radiation source may produce radiation such as gamma rays or charged particles. For example, the ionizing radiation source may produce charged particles such as alpha particles or beta particles. An example of an ionizing radiation source that may be used in a radioluminescent backlight is tritium gas, which emits beta particles. The half-life of tritium is over 12 years, which allows display backlight structures that are based on tritium to exhibit long lifetimes.

The phosphor may be formed from zinc sulfide doped with an impurity. Different dopants can be used to produce different respective colors of emitted light. For example, the phosphor may be formed from zinc sulfide doped with copper and manganese to emit yellow-orange light, zinc sulfide doped with copper to emit blue-green light, or zinc sulfide doped with silver to emit green light. Other types of phosphor may be used if desired (e.g., phosphors that emit white light).

Conventional backlights based solely on fluorescent lamps or light-emitting diodes can consume more power than desired, particularly in portable devices where battery life is a concern. In contrast, radioluminescent display backlights can produce backlight for many years without drawing battery power or electrical current from other power sources.

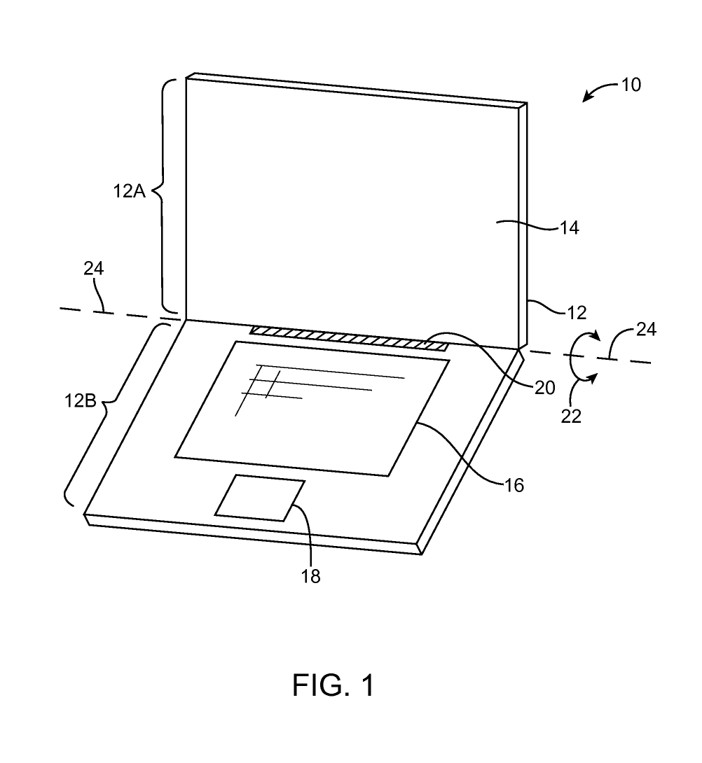

Illustrative electronic devices of the type that may be provided with displays that include radioluminescent backlight structures are shown in FIGS. 1, 2, 3, 4, and 5.

Electronic device 10 of FIG. 1 has the shape of a laptop computer and has upper housing 12A and lower housing 12B with components such as keyboard 16 and touchpad 18. Device 10 has hinge structures 20 to allow upper housing 12A to rotate in directions 22 about rotational axis 24 relative to lower housing 12B. Display 14 is mounted in upper housing 12A. Upper housing 12A, which may sometimes be referred to as a display housing or lid, is placed in a closed position by rotating upper housing 12A towards lower housing 12B about rotational axis 24.

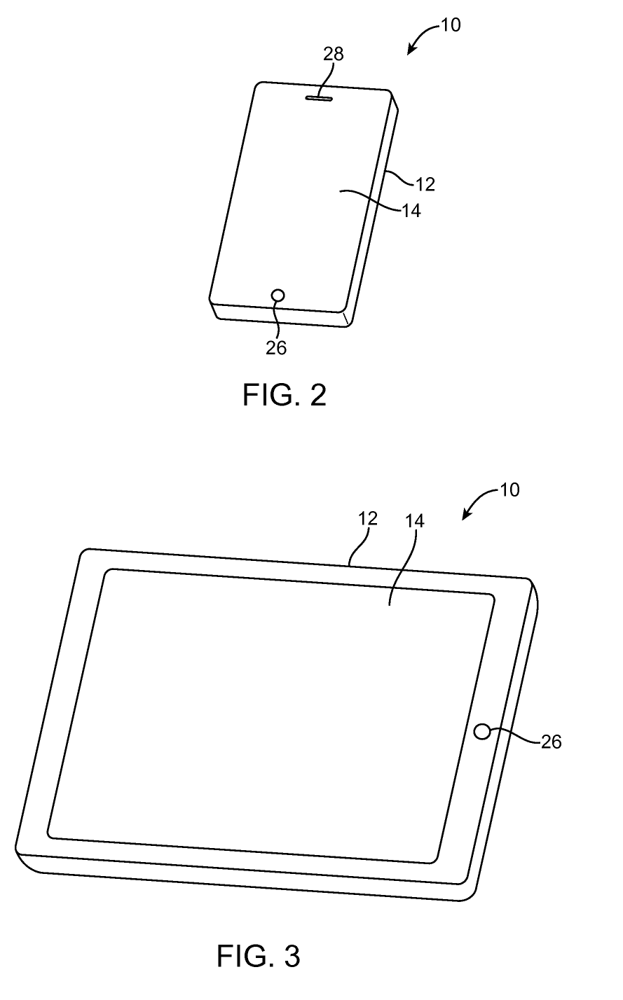

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an external layer with an opening to accommodate button 26.

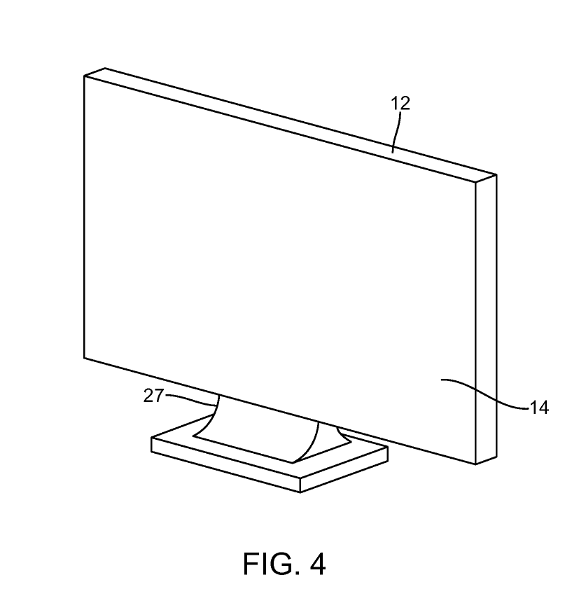

FIG. 4 shows an illustrative configuration for electronic device 10 in which device 10 is a computer display or a computer that has been integrated into a computer display. With this type of arrangement, housing 12 for device 10 is mounted on a support structure such as stand 27. Display 14 is mounted on a front face of housing 12.

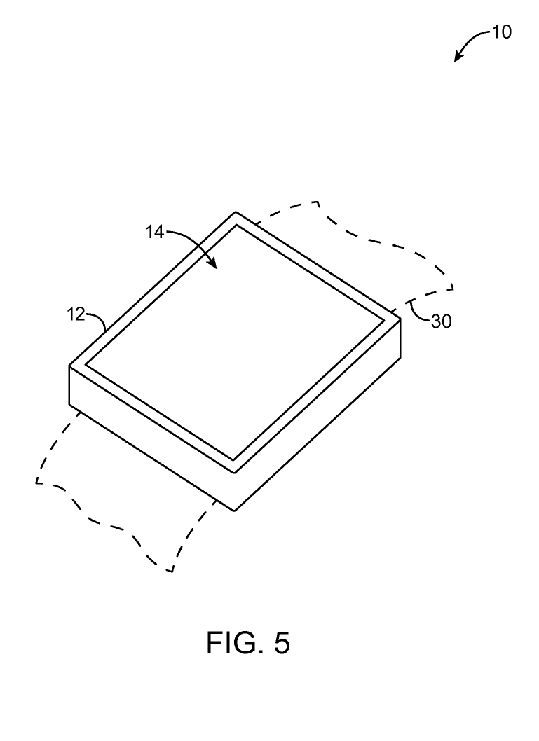

FIG. 5 shows and illustrative configuration for electronic device 10 in which device 10 is a portable device such as a wristwatch, pendant device, or other wearable or miniature device. Device 10 may, for example, be a small portable device such as a wristwatch device that is attached to the wrist of a user with strap 30.

The illustrative configurations for device 10 that are shown in FIGS. 1, 2, 3, 4, and 5 are merely illustrative. In general, electronic device 10 may be a laptop computer, a computer monitor containing an embedded computer, a tablet computer, a cellular telephone, a media player, or other handheld or portable electronic device, a smaller device such as a wristwatch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. Configurations for device 10 in which device 10 is a wristwatch device or other compact portable device in which space consumed by battery structures is at a premium benefit from the inclusion of radioluminescent backlight structures that do not draw battery power. In general, however, radioluminescent backlight structures may be used in any suitable electronic device.

Housing 12 of device 10, which is sometimes referred to as a case, is formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable pixel structures. The portions of display 14 that include the liquid crystal display components are sometimes referred to as forming a liquid crystal display module or liquid crystal display layers. The liquid crystal display module may be mounted in an electronic device so that the liquid crystal display module overlaps the radioluminescent backlight unit.

A display cover layer may cover the surface of display 14 or a display layer such as a color filter layer substrate or other portion of a display may be used as the outermost (or nearly outermost) layer in display 14. The outermost display layer may be formed from a transparent glass sheet, a clear plastic layer, or other transparent member.

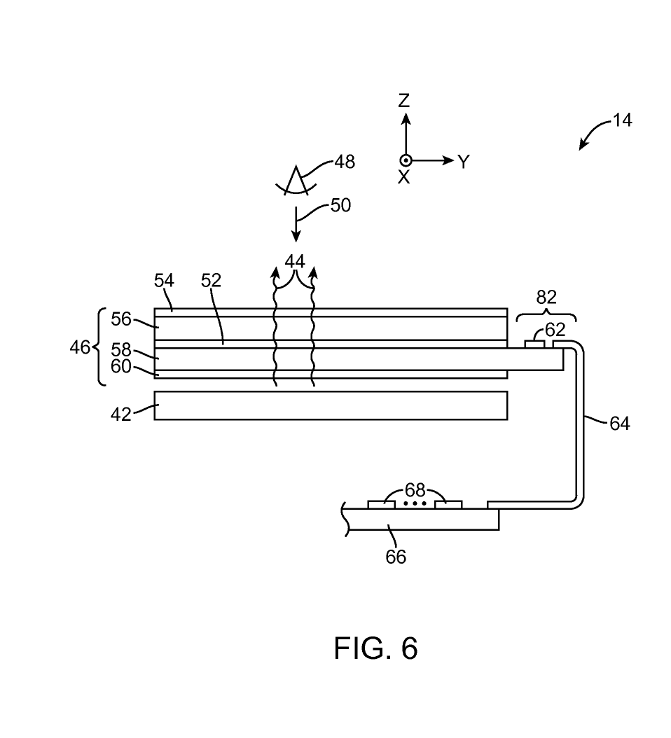

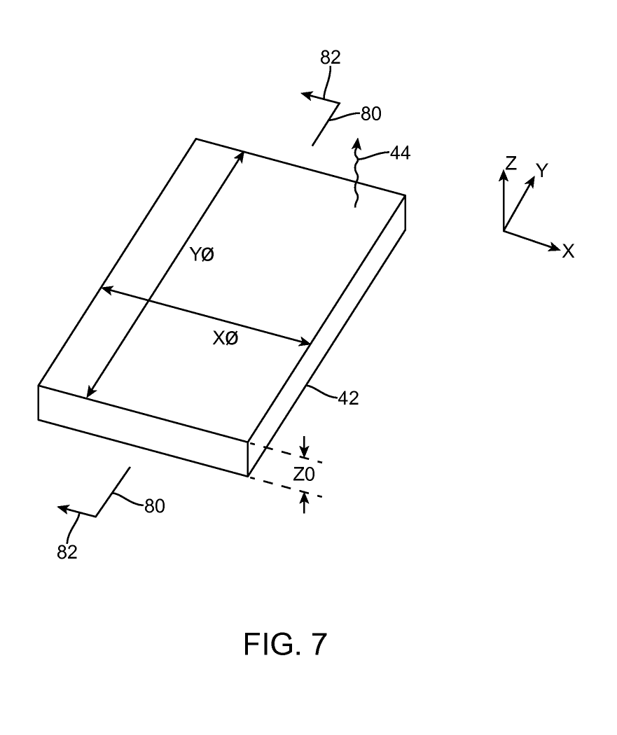

A cross-sectional side view of an illustrative configuration for display 14 of device 10 (e.g., for display 14 of the devices of FIG. 1, FIG. 2, FIG. 3, FIG. 4, FIG. 5, or other suitable electronic devices) is shown in FIG. 6. As shown in FIG. 6, display 14 may include backlight structures such as backlight unit 42 for producing backlight 44. Backlight unit 42 may be a radioluminescent backlight unit. During operation, backlight 44 travels outwards (vertically upwards in dimension Z in the orientation of FIG. 6) and passes through display pixel structures in liquid crystal display layers 46 (sometimes referred to as a liquid crystal display module or liquid crystal display structures). This illuminates any images that are being produced by the display pixels for viewing by a user. For example, backlight 44 illuminates images on display layers 46 that are being viewed by viewer 48 in direction 50. The images that are displayed may include moving image content (e.g., video clips, etc.) and/or static image content (text, graphics, photographs, etc.). A microprocessor, display driver circuitry, and other control circuitry may be used to display content on display 14.

Display layers 46 may be mounted in chassis structures such as a plastic chassis structure and/or a metal chassis structure to form a display structure for mounting in housing 12 or display layers 46 may be mounted directly in housing 12 (e.g., by stacking display layers 46 into a recessed portion in housing 12). Display layers 46 form a liquid crystal display or may be used in forming displays of other types.

Display layers 46 include a liquid crystal layer such a liquid crystal layer 52. Liquid crystal layer 52 is sandwiched between display layers such as display layers 58 and 56. Layers 56 and 58 are interposed between lower polarizer layer 60 and upper polarizer layer 54.

Layers 58 and 56 are formed from transparent substrate layers such as clear layers of glass or plastic. Layers 56 and 58 are layers such as a thin-film transistor layer (e.g., a thin-film-transistor substrate such as a glass layer coated with a layer of thin-film transistor circuitry) and/or a color filter layer (e.g., a color filter layer substrate such as a layer of glass having a layer of color filter elements such as red, blue, and green color filter elements arranged in an array). Conductive traces, color filter elements, transistors, and other circuits and structures are formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 is a thin-film transistor layer that includes an array of thin-film transistors and associated electrodes (display pixel electrodes) for applying electric fields to liquid crystal layer 52 and thereby displaying images on display 14. Layer 56 is a color filter layer that includes an array of color filter elements for providing display 14 with the ability to display color images. If desired, layer 58 may be a color filter layer and layer 56 may be a thin-film transistor layer. Layer 56 may, if desired, be a clear substrate or a substrate with a single color of color filter material (e.g., in configurations for display 14 in which display 14 is a monochrome display that displays monochrome images).

During operation of display 14 in device 10, control circuitry (e.g., one or more integrated circuits such as components 68 on printed circuit 66 of FIG. 6 and/or other circuitry) is used to generate information to be displayed on display 14 (e.g., display data). The information to be displayed is conveyed from circuitry 68 to display driver integrated circuit 62 using a signal path such as a signal path formed from conductive metal traces in flexible printed circuit 64 (as an example).

Display driver circuitry such as display driver integrated circuit 62 of FIG. 6 is mounted on thin-film-transistor layer driver ledge 82 or elsewhere in device 10. A flexible printed circuit cable such as flexible printed circuit 64 may be used in routing signals between printed circuit 66 and thin-film-transistor layer 58. If desired, display driver integrated circuit 62 may be mounted on printed circuit 66 or flexible printed circuit 64. Printed circuit 66 is formed from a rigid printed circuit board (e.g., a layer of fiberglass-filled epoxy) or a flexible printed circuit (e.g., a flexible sheet of polyimide or other flexible polymer layer).

Backlight structures 42 may include radioluminescent backlight structures. Radioluminescent backlight structures 42 include an ionizing radiation source such as tritium gas or other material that emits ionizing radiation and include a phosphor that emits light when struck by the ionizing radiation such as beta particles or other radiation that is emitted by the ionizing radiation source. The ionizing radiation source and phosphor may be contained within a sealed enclosure such as a glass enclosure. For example, borosilicate glass, which exhibits a relatively low coefficient of thermal expansion and which is transparent to visible light, may be used to form an enclosure for the radioluminescent backlight structures. Other materials for forming an enclosure for the backlight structures (e.g., other materials that include clear portions for allowing backlight to be emitted from the structures) may be used, if desired.

Radioluminescent backlight structures 42 may have a footprint that matches that of display layers 46. For example, if display 14 and display layers 46 have a rectangular outline, radioluminescent backlight structures 42 may have a mating rectangular shape. Configurations in which display 14, display layers 46, and radioluminescent backlight structures 42 have other shapes (e.g., circular shapes, oval shapes, non-rectangular shapes with straight edges, shapes with curved and/or straight edges, etc.) may be used if desired.

As shown in FIG. 7, radioluminescent backlight structures 42 may, as an example, have the shape of a rectangular prism (i.e., a rectangular box) with a rectangular outline (i.e., a rectangular footprint in the X-Y plane when viewed along the vertical axis Z of FIG. 7). Radioluminescent backlight structures 42 of FIG. 7 have a first lateral dimension X0 in dimension X, a second (perpendicular) lateral dimension Y0 in dimension Y, and a thickness Z0 in dimension Z. The interior of radioluminescent backlight structures 42 may contain an ionizing radiation source and phosphor.

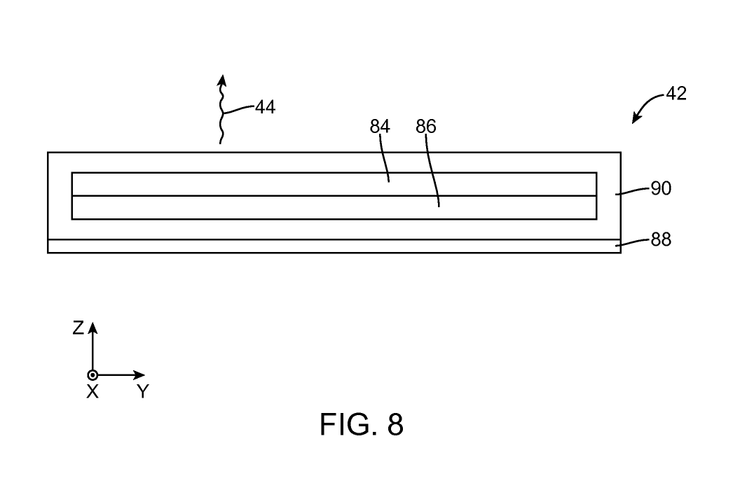

A cross-sectional side view of radioluminescent backlight structures 42 of FIG. 7 taken along line 80 and viewed in direction 82 is shown in FIG. 8. As shown in FIG. 8, radioluminescent backlight structures 42 may include ionizing radiation source 86, phosphor 84, enclosure 90, and reflector 88. Ionizing radiation source 86 may produce beta particles, alpha particles, gamma rays, or other ionizing radiation. Phosphor 84 may be formed from a material that emits light when exposed to the ionizing radiation from ionizing radiation source 86. Enclosure 90 may be formed from a hollow borosilicate glass box with a rectangular outline when viewed along dimension Z and a rectangular cross-sectional shape when viewed in dimension X (as shown in FIG. 8). Phosphor 84 may be formed as a coating on one or more of the inner surfaces of enclosure 90.

During operation, backlight 44 that is produced within phosphor 84 may be emitted upwards in direction Z. Backlight that is initially emitted downwards along the negative Z direction may be reflected back in the upwards direction by reflector 88. Reflector 88 may be formed from a white layer of plastic, a metalized layer, a sheet of metal, a layer of white paper, a layer of material coated with a reflective shiny surface, a reflective coating of metal on another layer of metal or a non-metallic substrate, plastic, metal or plastic or other reflective material that is coated on the lower surface of enclosure 90, or other suitable reflective structures.

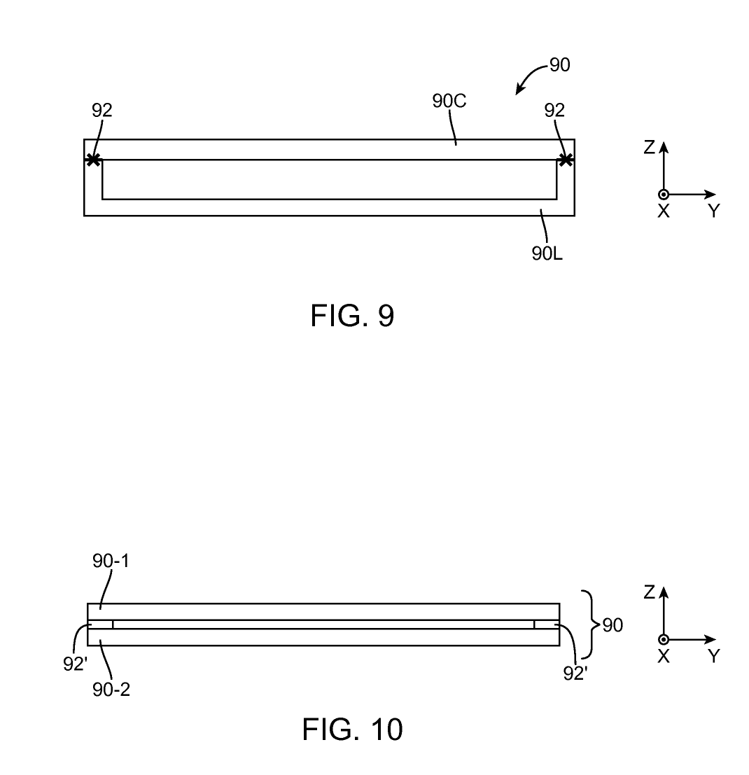

FIG. 9 is a cross-sectional side view of illustrative radioluminescent backlight structures 42 in a configuration in which enclosure 90 has been formed from a lower portion such as open-topped hollow borosilicate glass box 90L and an upper portion such as planar rectangular borosilicate glass cover 90C. Coupling structures 92 such as glass frit, a solid glass gasket, portions of the borosilicate glass from structures 90L and 90C, adhesive, or other structures may be used in attaching structures 90C and 90L together so as to form a seal that encloses ionizing radiation source 86 and phosphor 84.

FIG. 10 is a cross-sectional side view of illustrative radioluminescent backlight structures 42 in a configuration in which enclosure 90 has been formed from a lower structure such as plate 90-2 (e.g., a rectangular plate of borosilicate glass) and an upper structure such as plate 90-1 (e.g., a mating rectangular plate of borosilicate glass). Coupling structures 92′ such as glass frit, a solid glass gasket, portions of the borosilicate glass from structures 90-2 and 90-1, adhesive, or other structures may be used in sealing structures 90-1 and 90-2 together to enclose ionizing radiation source 86 and phosphor 84.

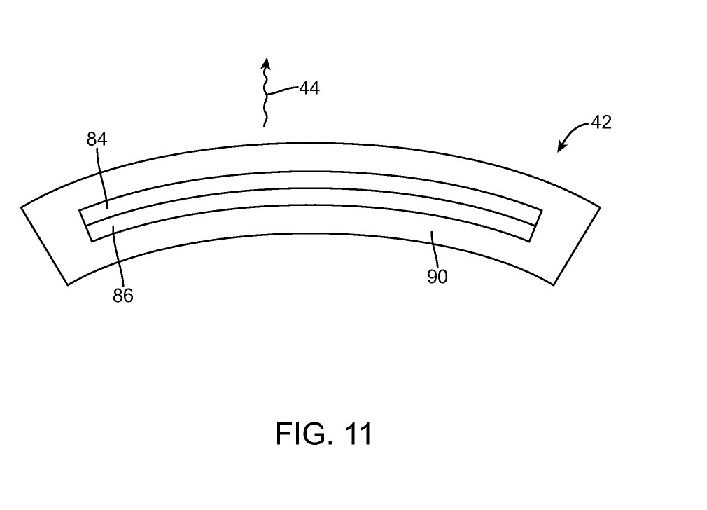

If desired, display 14 may have a curved shape when viewed from the side. For example, display 14 may have a shape that exhibits a radius of curvature that matches the radius of curvature of a human wrist (e.g., when device 10 is a wrist-mounted device). A cross-sectional side view of an illustrative curved configuration for radioluminescent backlight structures 42 is shown in FIG. 11. As shown in FIG. 11, ionizing radiation source 86 may have a curved cross-sectional shape, phosphor 84 may have a curved cross-sectional shape, and enclosure 90 may have a curved cross-sectional shape. Enclosure 90 may have upper and lower plates that run parallel to each other and may have curved upper and lower surfaces and/or planar upper and lower surfaces.

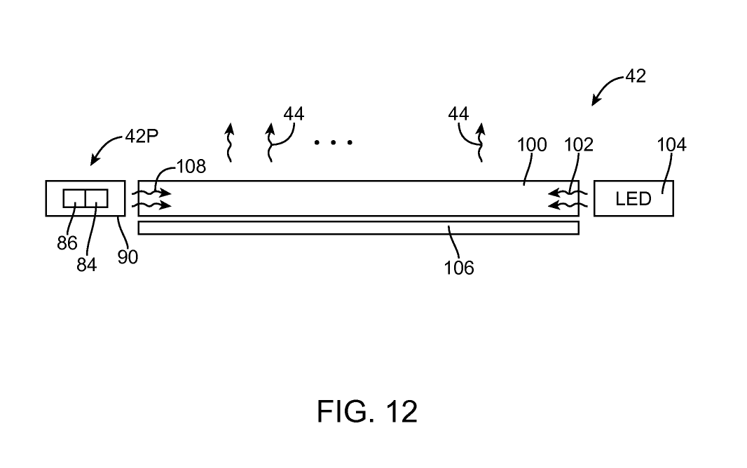

FIG. 12 shows how a hybrid backlight unit may be formed that uses both radioluminescent lighting and lighting from a light source such as a light-emitting diode. As shown in the cross-sectional side view of FIG. 12, backlight unit 42 of FIG. 12 may have a light guide plate such as light guide plate 100. Light guide plate 100 may be formed from a transparent planar member such as a sheet of clear plastic or glass. Light guide plate 100 may have a rectangular footprint or other suitable shapes.

Light may be provided to the edges of light guide plate 100 from multiple light sources. For example, light 102 may be launched into light guide plate 100 from a light source such as light-emitting diode light source 104. Light-emitting diode light source 104 may be formed from one or more light-emitting didoes that are coupled to the edge of light guide plate 100. For example, light-emitting diode light source 104 may be based on an array of light-emitting diodes that run along one or more edges of light guide plate 100. The light-emitting diodes may emit white light or light of other colors. Radioluminescent light source 42P may have one or more enclosures 90 that extend along one or more of the edges of light guide plate 100. For example, radioluminescent light source 42P may be formed from an elongated rod-shaped enclosure that runs along one of the edges of light guide plate 100 or may be formed from an array of enclosures that run along one of the edges of light guide plate 100. Configurations in which radioluminescent light source 42P is configured to emit light 108 into multiple light guide plate edges in light guide plate 100 may also be used.

As shown in the illustrative configuration of FIG. 12, radioluminescent light source 42P may emit light 108 into an edge of light guide plate 100 opposing the edge into which light 102 is emitted by light-emitting diode light source 104. If desired, radioluminescent light source 42P and/or light-emitting diode light source 104 and/or other light sources may emit light into the same edge of light guide plate 100 or into other suitable edges of light guide plate 100. Radioluminescent light source 42P may include ionizing radiation source 86 and phosphor 84 housed within enclosure 90.

Light that has been provided to the interior of light guide plate 100 through the edges of light guide plate 100 may travel within light guide plate 100 in accordance with the principal of total internal reflection. Light scattering features such as pits and/or bumps may be formed on the upper and/or lower surfaces of light guide plate 100 to assist in scattering light such as light 102 and light 108 vertically upwards out of the light guide plate to serve as backlight 44 for display 14. Reflector 106 may be provided to help reflect light that has been scattered downward back in the upward direction. Reflector 106 may be formed from a reflective material such as white plastic, plastic coated with metal, a metal layer, a reflective dielectric stack, or other reflective structures.

In the illustrative configuration of FIG. 12, light is launched into light guide plate 100 from both radioluminescent light source 42P and light-emitting diode light source 104. In this type of arrangement, display 14 can be illuminated with light from radioluminescent light source 42P when it is desired to conserve power by deactivating light-emitting diode light source 104. In bright ambient lighting conditions or other situations in which it is desired to supplement the light from radioluminescent light source 42P, light-emitting diode light source 104 may be switched into use. The amount of light emitted by light-emitting diode light source 104 when activated may be controlled based on user settings and/or ambient lighting conditions and other criteria.

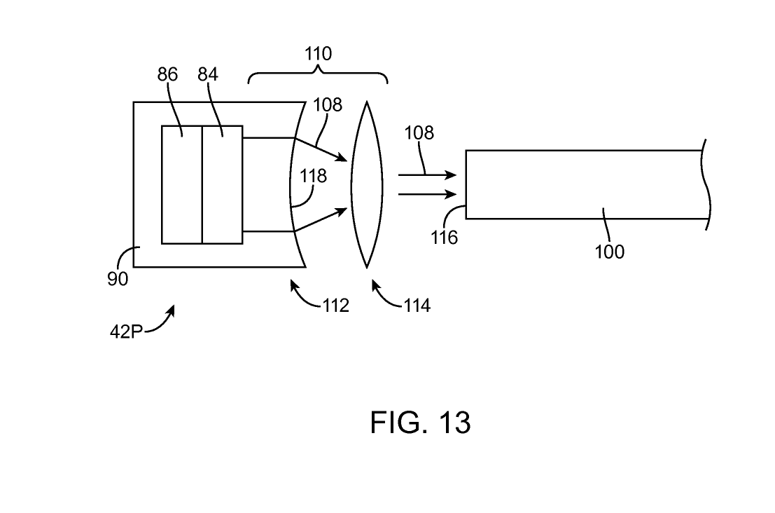

Light concentrating structures may be used to help launch light into the edge of light guide plate 100. As an example, lens structures may be used to focus light that is being emitted by radioluminescent light source 42P. This type of arrangement is shown in the cross-sectional side view of FIG. 13. As shown in FIG. 13, lens structures 110 may include portions of glass enclosure 90 in radioluminescent light source 42P. Lens structures 110 may, for example, include integral concave lens 112, which is formed from concave surface 118 on the side of enclosure 90 that faces edge 116 of light guide plate 100. Lens structures 110 may also include one or more stand-alone lenses such as lens 114. Using lens structures such as concave integral lens 112 and/or external lens 114, light 118 from radioluminescent light source 42P may be focused onto edge 116 of light guide plate 100 and thereby coupled efficiently into the interior of light guide plate 100.

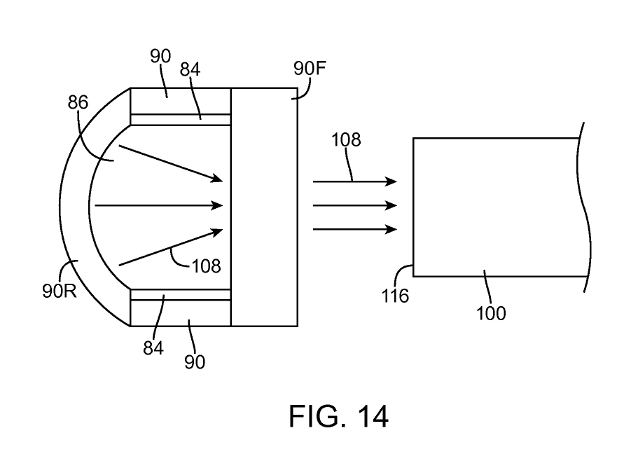

In the illustrative configuration of FIG. 14, ionizing radiation source 86 and phosphor 84 of radioluminescent light source 42P are housed within an enclosure that has a curved rear portion. As shown in FIG. 14, curved rear portion 90R of enclosure 90 may reflect light 108 from phosphor 84 and thereby help focus light 108 onto edge 116 of light guide plate 100. A metal coating or other reflective coating may be provided on the inner or outer surface of rear portion 90R to enhance reflectivity. If desired, enclosure 90 may have a front portion such as front portion 90F that includes concave, convex, and/or planar surfaces to help couple light 108 into edge 116 of light guide plate 100.

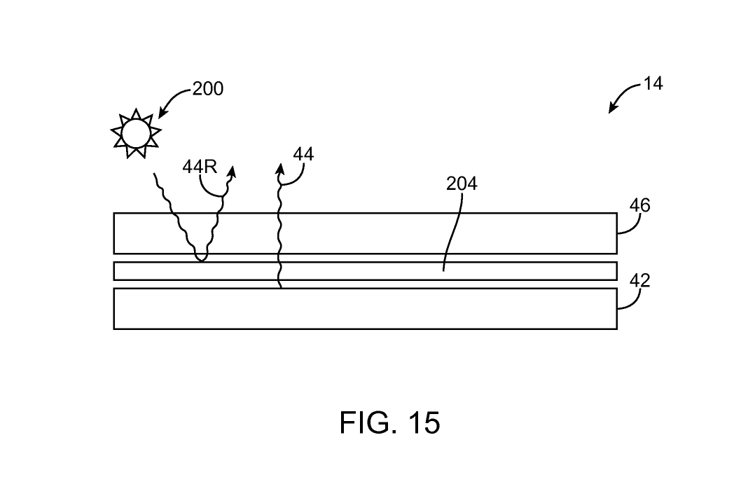

A partly reflective layer such as layer 204 of FIG. 15 may be incorporated into display 14 between liquid crystal display unit 46 and radioluminescent backlight unit 42. Layer 204 may be formed from a clear substrate of glass or plastic covered with a thin layer of metal or a dielectric stack or may be formed from other structures that exhibit partial light transmission and partial light reflection at the wavelengths of light associated with backlight 44.

When ambient light conditions are dim, backlight 44 from radioluminescent backlight unit 42 of FIG. 15 can provide liquid crystal display unit 46 with backlight 44. When ambient light from the sun or other ambient light source 200 is bright, reflected ambient light ray 44R may be generated by reflecting light from source 200 off of reflector 204. In the presence of partially reflecting layer 204 (e.g., a layer that reflects about 20-70% of the light incident upon the layer or other suitable fraction), some of the light emitted by radioluminescent backlight unit 42 will be reflected downwards from reflector 204, thereby decreasing radioluminescent backlight efficiency. However, in bright ambient lighting conditions, where a dim radioluminescent backlight could potentially be overwhelmed, the presence of bright reflected ambient light such as reflected ambient light 44R of FIG. 15 may help provide sufficient backlight illumination for display 14.

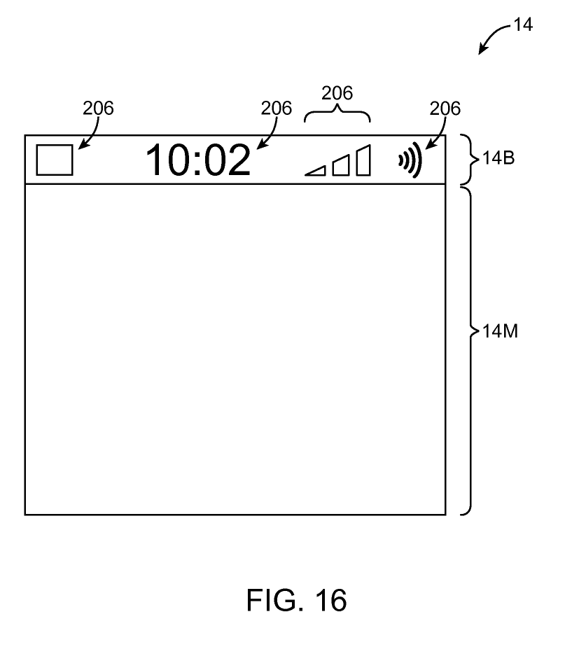

It may be desirable to provide radioluminescent backlight for a portion of a display in device 10. As an example, an arrangement of the type shown in FIG. 16 may be used in which display 14 has a main rectangular portion 14M and a border portion 14B. Border portion 14B in the example of FIG. 16 is formed from a horizontal strip of display 14 along the upper edge of display 14. Border portion 14B may be formed form an integral portion of a liquid crystal display unit that also serves as the active display structure in main rectangular portion 14M or may be formed from a separate display structure. With the illustrative configuration of FIG. 16, border portion 14B has the shape of a horizontal strip and may overlap a matching strip-shaped radioluminescent backlight.

Main portion 14M may overlap a backlight unit with a rectangular footprint. The backlight unit that provides backlight to main portion 14M of display 14 may have a rectangular light guide plate such as light guide plate 100 of FIG. 12 that is illuminated by a light source such as a light-emitting diode light source 104 of FIG. 12. The radioluminescent light source under portion 14B of display 14 in FIG. 16 may have a rectangular shape (e.g., a rectangular glass enclosure shape) or may be formed by launching light from a radioluminescent light source into the edge of a light guide plate.

The light guide plate into which light for portion 14B is launched may be separate from the light guide plate used to illuminate main portion 14M of display 14 or may be formed from an integral portion of the light guide plate that illuminates main portion 14M of display 14. In arrangements in which an integral light guide plate configuration is used, different densities and shapes of pits, bumps, and other light scattering features may be provided in the portion of the light guide plate that overlaps border area 14B of display 14 relative to the portion of the integral light guide plate in main area 14M.

Radioluminescent backlit portion 14B of display 14 may display information 206 such as informative icons, time and date characters, numbers and letters, wireless signal strength indicators, battery capacity indicators, status indicators that indicate whether a user of device 10 has an incoming text message, email, or telephone call, status indicators that provide additional status information, or other status indicators. It may be desirable to provide image elements 206 in region 14B that relate to information that a user checks frequently, such as sports scores, stock prices, the time, the date, or other real time information. In general, display regions such as region 14B that are selectively lit by radioluminescent backlight may be used to display any suitable information of interest to a user.

If desired, the portion of display 14 that is backlit by radioluminescent light source 42 may have shapes other than the rectangular strip shape of FIG. 16. For example, display 14 may be provided with a rectangular ring-shaped radioluminescent border, may be provided with a border that covers all or part of one or more of the four edges of display 14 of FIG. 16, may be provided with a border that covers all or port of a non-rectangular peripheral portion of display 14, may be provided as a separate rectangular display that is mounted adjacent to main display 14, or may otherwise be formed in device 10 as part of display 14 or to supplement display 14. If desired, radioluminescent backlight for display 14 may be provided using non-rectangular backlight structures. For example, display 14 and backlight unit 42 may each have a circular footprint, an oval footprint, or other shape with curved and/or straight edges, display 14 may have border regions or other partial display regions with curved edges, straight edges, combinations of straight and curved edges, rectangular shapes that are not located on the periphery of display 14, non-rectangular outlines, etc.

If desired, backlight unit 42 in display 14 and device 10 may include photoluminescent material. The photoluminescent material may be provided in the form of a coating on enclosure 90 or other support structures in addition to or instead of providing backlight unit 42 with radioluminescent structures. Following exposure to light, photoluminescent material emits light that may serve as backlight 44 until the amount of light being emitted decays to a small amount. Light from photoluminescent backlight structures may be used in dim lighting conditions to provide a user with the ability to view images on display 14. In arrangements with both radioluminescent and photoluminescent structures, photoluminescent backlight may supplement the radioluminescent light from the radioluminescent backlight structures.

Photoluminescent backlight structures may be used, for example, to provide backlight to portions of display 14 that do not overlap radioluminescent backlight structures. Photoluminescent backlight structures may also be used to provide backlight in displays that do not contain radioluminescent structures. For example, photoluminescent backlight structures may be used to provide the sole source of backlight in a display or may be used as a light source in a hybrid backlight that contains multiple light sources (e.g., light-emitting diode light sources). Display 14 may contain a photoluminescent light source, a radioluminescent light source, and a light-emitting diode light source, if desired. Photoluminescent backlight structures, radioluminescent backlight structures, and/or light-emitting diode backlight structures may also be used with other types of displays such as organic light-emitting diode displays. As an example, a display may have one portion that is illuminated using an array of light-emitting diodes and another portion that contains a liquid crystal display module having backlight structures based on photoluminescent structures, radioluminescent structures and/or light-emitting diode structures. Displays of these types may serve as display 14 in device 10.

The foregoing is merely illustrative and various modifications can be made by those skilled in the art without departing from the scope and spirit of the described embodiments. The foregoing embodiments may be implemented individually or in any combination.

What is claimed is:

1. A display, comprising:
liquid crystal display layers that display images; and
radioluminescent backlight structures that produce backlight that passes through the liquid crystal display layers.

2. The display defined in claim 1 wherein the radioluminescent backlight structures comprise a phosphor that emits the backlight.

3. The display defined in claim 2 wherein the radioluminescent backlight structures comprises an ionizing radiation source that emits ionizing radiation, wherein the phosphor emits the backlight in response to being struck by the ionizing radiation.

4. The display defined in claim 3 wherein the ionizing radiation source comprises tritium gas.

5. The display defined in claim 4 wherein the radioluminescent backlight structures comprise an enclosure that encloses the tritium gas and the phosphor and wherein the display further comprises a partially reflective layer between the liquid crystal layers and the radioluminescent backlight structures.

6. The display defined in claim 3 further comprising a glass enclosure with a curved surface that encloses the phosphor and the ionizing radiation source.

7. The display defined in claim 6 wherein the glass enclosure comprises a rectangular box having a rectangular footprint that matches a rectangular footprint of the liquid crystal display layers.

8. The display defined in claim 6 wherein the radioluminescent backlight structures comprise a light guide plate into which the backlight is provided from the phosphor.

9. The display defined in claim 8 wherein the radioluminescent backlight structures comprise a light-emitting diode that emits light into the light guide plate.

10. The display defined in claim 1 wherein the liquid crystal display layers comprise:
a layer of liquid crystal material;
a color filter layer;
a thin-film transistor layer; and
polarizer layers.

11. The display defined in claim 1 wherein the radioluminescent backlight structures comprise:
an ionizing radiation source that emits ionizing radiation, wherein the phosphor emits the backlight in response to being exposed to the ionizing radiation;
an enclosure that encloses the ionizing radiation source; and
lens structures that focus the backlight emitted from the phosphor onto an edge of the light guide plate.

12. An electronic device, comprising:
a housing; and
a display in the housing, wherein the display includes liquid crystal display layers that display images and radioluminescent structures that produce light that illuminates the images.

13. The electronic device defined in claim 12 further comprising a strap coupled to the housing, wherein at least a portion of the display has a curved surface.

14. The electronic device defined in claim 12 wherein the display has a first area that is provided with light from the radioluminescent structures and has a second area that emits light that is not from any radioluminescent structures.

15. A display backlight, comprising:
an ionizing radiation source that emits ionizing radiation; and
a phosphor that emits light when struck by the ionizing radiation.

16. The display backlight defined in claim 15 further comprising an enclosure that encloses the ionizing radiation source and the phosphor.

17. The display backlight defined in claim 16 wherein the ionizing radiation source comprises a source of beta particles.

18. The display backlight defined in claim 16 wherein the ionizing radiation source comprises tritium and wherein the enclosure comprises a curved surface.

19. The display backlight defined in claim 18 wherein the phosphor comprises zinc sulfide.

20. The display backlight defined in claim 16 wherein the enclosure comprises a rectangular glass box.
